(19) United States
(12) Patent Application Publication
(10) Pub. No.: US 2025/0038895 A1
(43) Pub. Date: Jan. 30, 2025

(54) METHODS AND DEVICES FOR APPLYING DYNAMIC CODEBOOK FOR HARQ-ACK FEEDBACK

(71) Applicant: ZTE Corporation, Shenzhen (CN)

(72) Inventors: Hanchao LIU, Shenzhen (CN); Feng XIE, Shenzhen (CN); Minzhe ZHAO, Shenzhen (CN); Fei WANG, Shenzhen (CN)

(73) Assignee: ZTE Corporation, Shenzhen (CN)

(21) Appl. No.: 18/915,558

(22) Filed: Oct. 15, 2024

Related U.S. Application Data
(63) Continuation of application No. PCT/CN2022/102898, filed on Jun. 30, 2022.

(51) Int. Cl. H04L 1/1829; H04L 5/00

(52) U.S. Cl. CPC H04L 1/1861; H04L 1/1854; H04L 5/0055

(57) ABSTRACT

The present disclosure describes methods, system, and devices for applying dynamic codebooks for hybrid automatic repeat request acknowledgement (HARQ-ACK) feedback. One method includes transmitting, by a wireless communication device, HARQ-ACK based on more than one dynamic HARQ-ACK codebooks, wherein each dynamic HARQ-ACK codebook corresponds to a timing advance group (TAG). Another method includes receiving, by a wireless communication node from a wireless communication device, HARQ-ACK based on more than one dynamic HARQ-ACK codebooks, wherein each dynamic HARQ-ACK codebook corresponds to a TAG.

### TECHNICAL FIELD

The present disclosure is directed generally to wireless communications. Particularly, the present disclosure relates to methods and devices for applying dynamic codebooks for hybrid automatic repeat request acknowledgement (HARQ-ACK) feedback.

### BACKGROUND

Wireless communication technologies are moving the world toward an increasingly connected and networked society. In the present disclosure, various embodiments are described for applying dynamic codebooks for hybrid automatic repeat request acknowledgement (HARQ-ACK) feedback.

When the wireless communications perform under carrier aggregation (CA), there may be relatively longer latency for information transmission between various carriers belonging to different timing advance groups (TAGs). There may be various issues/problems associated with HARQ-ACK information feedback with dynamic codebook. For example, one of the issues/problems may be that, when the dynamic codebook is used for HARQ-ACK information feedback for dynamic scheduling (e.g. downlink assignment indicated in the DCI), a total downlink assignment index (tDAI) or counter downlink assignment index (cDAI) may not be correctly indicated in a downlink control information (DCI).

Improved proper designs of control mechanisms for applying dynamic codebooks for hybrid automatic repeat request acknowledgement (HARQ-ACK) feedback may help to improve the efficiency of the radio access network. The present disclosure may address at least one of issues/problems associated with the existing system to improve the performance of the wireless communication.

### SUMMARY

This document relates to methods, systems, and devices for wireless communication, and more specifically, for applying dynamic codebooks for hybrid automatic repeat request acknowledgement (HARQ-ACK) feedback. The various embodiments in the present disclosure may be beneficial to improve applying dynamic codebooks for HARQ-ACK feedback, to increase the resource utilization efficiency, and to boost latency performance of the wireless communication.

In one embodiment, the present disclosure describes a method for wireless communication. The method includes transmitting, by a wireless communication device, hybrid automatic repeat request acknowledgement (HARQ-ACK) based on more than one dynamic HARQ-ACK codebooks, wherein each dynamic HARQ-ACK codebook corresponds to a timing advance group (TAG).

In one embodiment, the present disclosure describes a method for wireless communication. The method includes receiving, by a wireless communication node from a wireless communication device, hybrid automatic repeat request acknowledgement (HARQ-ACK) based on more than one dynamic HARQ-ACK codebooks, wherein each dynamic HARQ-ACK codebook corresponds to a timing advance group (TAG).

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of various embodiments in the present disclosure.

FIG. 1C shows another schematic diagram of various embodiments in the present disclosure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a flow diagram of a non-limiting embodiment for wireless communication.

FIG. 6 shows a flow diagram of a non-limiting embodiment for wireless communication.

FIG. 7 shows a flow diagram of a non-limiting embodiment for wireless communication.

FIG. 8 shows a flow diagram of a non-limiting embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for applying dynamic codebooks for hybrid automatic repeat request acknowledgement (HARQ-ACK) feedback. In various embodiments, applying dynamic codebooks for HARQ-ACK feedback may include applying and/or using TAG-specific dynamic codebooks for HARQ-ACK feedback.

Next generation (NG), or 5th generation (5G), wireless communication may provide a range of capabilities from downloading with fast speeds to support real-time low-latency communication. New generation (NG) mobile communication system are moving the world toward an increasingly connected and networked society. High-speed and low-latency wireless communications rely on efficient network resource management and allocation between user equipment and wireless access network nodes (including but not limited to wireless base stations).

Carrier aggregation (CA) is a key technology for multi-frequency fusion in cellular mobile communication systems (e.g., 4G, or 5G). CA includes intra-timing advance group (intra-TAG) carrier aggregation and cross-TAG carrier aggregation. In the case of using a dynamic codebook for downlink HARQ ACK/NACK, a UE may need to be notified of a counter downlink assignment index (DAI) and a total DAI of this scheduling through downlink control information (DCI). In some implementations, a total DAI may need scheduling information on all carriers, including a primary cell (Pcell) and all secondary cells (Scells). This requires that the DCI on one carrier needs to acquire the scheduling information on other carriers, and the exchange of scheduling information between different carriers may take a certain amount of time, which may be known as the delay for exchange of scheduling information. For cross-TAG CA, the scheduling information exchange delay between carriers of different TAGs may usually be larger, which may seriously affect the scheduling timing and even cause scheduling failure.

The present disclosure describes various embodiments for transmitting hybrid automatic repeat request acknowledgement (HARQ-ACK) based on more than one dynamic HARQ-ACK codebooks, wherein each dynamic HARQ-ACK codebook corresponds to a timing advance group (TAG), which addresses at least one of the issues/problems associated with the current system.

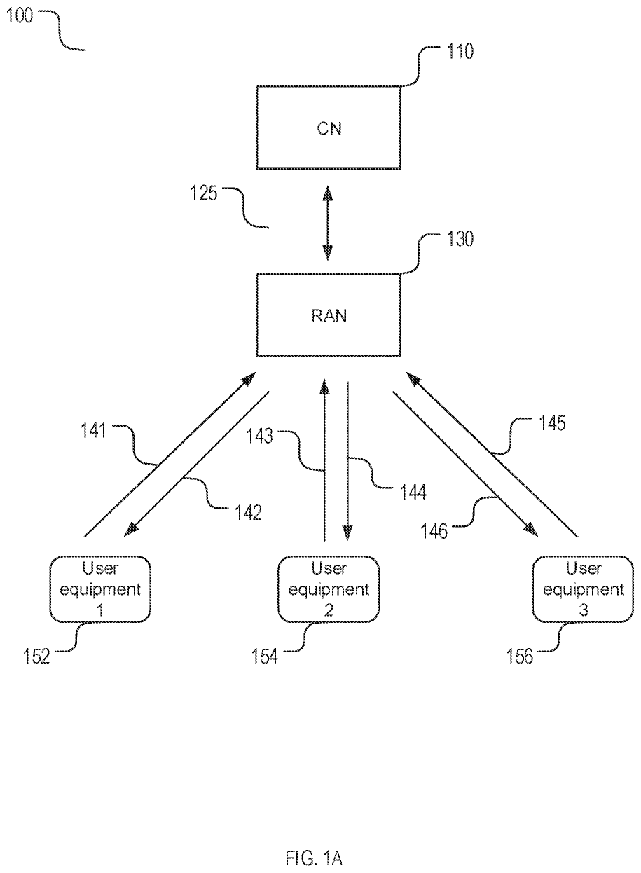

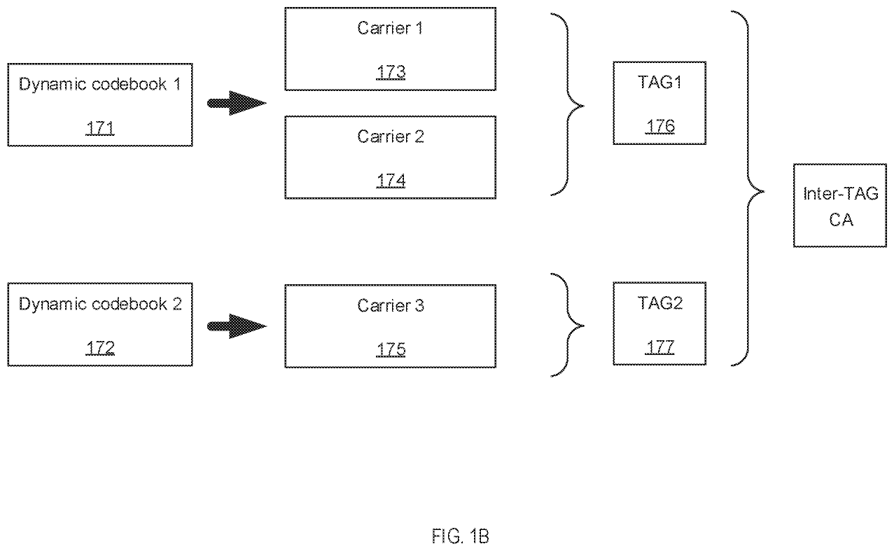

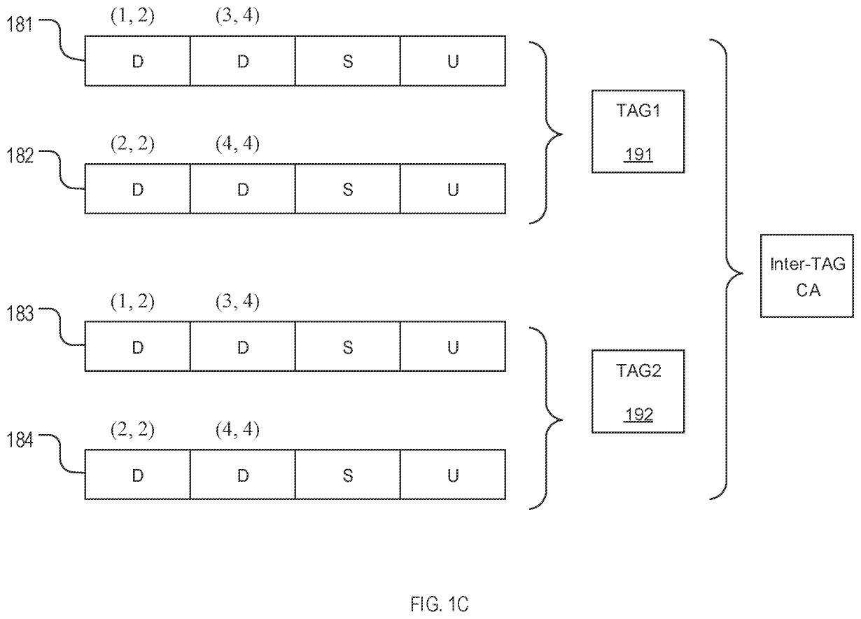

FIG. 1 shows a wireless communication system 100 including a core network (CN) 110, a radio access network (RAN) 130, and one or more user equipment (UE) (152, 154, and 156). The RAN 130 may include a wireless network base station, or a NG radio access network (NG-RAN) base station or node, which may include a nodeB (NB, e.g., a gNB) in a mobile telecommunications context. In one implementation, the core network 110 may include a 5G core network (5GC), and the interface 125 may include a new generation (NG) interface.

Referring to FIG. 1A, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and a uplink communication may include a physical uplink shared channel (PUSCH) or a physical uplink control channel (PUCCH). The one or more downlink communication (142, 144, and/or 146) and/or the one or more uplink communication (141, 143, and/or 145) may be transmitted as one or more TAGS.

In some implementations, for example, in 5G new radio (NR) implementations, a carrier aggregation (CA) includes intra-TAG CA and inter-TAG CA. Intra-TAG CA refers to CA in which all carriers belong to a same TAG; inter-TAG CA refers to CA in which aggregated carriers belong to different TAGs.

In some other implementations, carriers belonging to a same TAG may share one timing advance (TA). The TA adjustment signaling, for example, TA medium access control (MAC) control element (CE), received by the UE on one carrier may be multiplexed to other carriers belonging to the same TAG.

In some other implementations, the carriers deployed on a same nodeB (eNB or gNB) site are configured as belonging to a same TAG. Carriers that are not deployed on the same nodeB site are configured as carriers that belong to different TAGs. Therefore, for a carrier aggregation deployed on a same nodeB site, it is generally considered to be the intra-TAG CA, and for a carrier aggregation deployed on different nodeB sites, it is generally considered to be the inter-TAG CA.

In some other implementations, HARQ-ACK codebook refers to the entirety of the HARQ information fed back by a UE on one HARQ feedback resource (e.g., PUCCH or PUSCH). The timing parameter (e.g., K1) is one of the important parameters for determining the HARQ-ACK codebook. The timing parameter (e.g., K1) may be a time offset value between PDSCH and PUCCH or PUSCH for HARQ-ACK feedback. The way of indicating the K1 parameter is that the network firstly configures the K1 value set through radio resource control information element (RRC IE), and then dynamically indicates a value in the K1 value set through the HARQ feedback indication field in a downlink control information (DCI).

In some other implementations, a HARQ ACK/NACK codebook may be dynamics or semi-static. A dynamic HARQ ACK/NACK codebook refers to a codebook generation method in which the size of the HARQ ACK/NACK codebook can be determined dynamically based on downlink assignment cross all carriers for CA. The dynamic codebook mechanism for 5G New Radio (NR) and long-term evolution (LTE) may be similar. The value of counter DAI in the DCI indicates the accumulated number of PDSCHs currently. The statistical sequence of the accumulated number is as follows: firstly according to the ascending order of the serving cell index included in CA for codebook, and then according to the ascending order of PDSCH time domain occasion. The value of total DAI in the DCI indicates the total number of PDSCHs for CA so far.

One of the main problems for HARQ ACK/NACK feedback with dynamic codebook is that: for inter-TAG CA, DCI on each carrier needs DAIs on other carriers to calculate the total DAI. Scheduling information exchange delay cross carriers in different TAGs is usually very large, which seriously affects the scheduling timing and even causes scheduling failure.

The present invention describes various embodiments for applying dynamic codebooks for hybrid automatic repeat request acknowledgement (HARQ-ACK) feedback. When dynamic codebook is used for HARQ ACK/NACK feedback for inter-TAG CA, UE may use more than one dynamic codebook at the same time, and each dynamic codebook corresponds to one TAG. When the UE is configured with multiple carriers (such as CA), and these carriers belong to multiple different TAGs, UE may use more than one dynamic codebooks to perform HARQ ACK/NACK feedback. Wherein each dynamic codebook is used for the carriers belonging to one of the TAGs. For inter-TAG CA, one dynamic codebook is used for carriers belonging to one of the TAGs; another dynamic codebook is used for carriers belonging to another one of the TAGs. When UE simultaneously receives PDSCHs on carriers belonging to multiple TAGs for CA, UE may simultaneously use multiple dynamic codebooks for HARQ ACK/NACK feedback, and each dynamic codebook corresponds to one TAG.

For an unlimiting example, an inter-TAG CA situation is shown in FIG. 1B. There may be more than one dynamic codebooks, which are used for HARQ-ACK feedback. Each dynamic codebook correspond to a TAG and each dynamic codebook is used for carriers belonging to one of the TAGs, for example, a dynamic codebook 1 (171) for a TAG1 (176) and a dynamic codebook 2 (172) for another TAG (TAG2, 177). The TAG1 (176) may comprises one or more carriers, for example, a Carrier 1 (173) and a Carrier 2 (174). The TAG2 (177) may comprises one or more carriers, for example, a Carrier 3 (177).

DCI on a carrier may needs to determine counter DAI and total DAI based on downlink assignment on other carriers in the same TAG. That is to say, one counter DAI and one total DAI correspond to one TAG. For inter-TAG CA, UE may simultaneously receive counter DAIs and total DAIs for more than one dynamic codebooks, and each dynamic codebook corresponds to one TAG.

For an unlimiting example, an inter-TAG CA situation is shown in FIG. 1C. There may be more than one dynamic codebooks, which are used for HARQ-ACK feedback. A first carrier 181 and a second carrier 182 may belong to a first TAG (TAG1, 191); and a third carrier 183 and a fourth carrier 184 may belong to a second TAG (TAG2, 192). These four carriers may be all time division duplexing (TDD) carriers and downlink-uplink configuration with a pattern: a period comprises four slots, wherein a first slot is a downlink (D) slot, a second slot is a downlink (D) slot, a third slot is a special(S) slot, a fourth slot is an uplink (U) slot. Merely as non-limiting examples, for the first carrier, downlink assignment on a first slot with (counter DAI, total DAI) being (1, 2); and for the second carrier, downlink assignment on a first slot with (counter DAI, total DAI) being (2, 2). In some implementations, (counter DAI, total DAI) may be denoted as (cDAI, tDAI). Merely as non-limiting examples, for the first carrier, downlink assignment on a second slot with (cDAI, tDAI) being (3, 4); and for the second carrier, downlink assignment on a second slot with (cDAI, tDAI) being (4, 4). There may be a single dynamic codebook for the first carrier and the second carrier, both of which belong to the TAG1.

There may be another single dynamic codebook for the third carrier and the fourth carrier, both of which belong to the TAG2. Merely as non-limiting examples, for the third carrier, downlink assignment on a first slot with (cDAI, tDAI) being (1, 2); and for the fourth carrier, downlink assignment on a first slot with (cDAI, tDAI) being (2, 2). For the third carrier, downlink assignment on a second slot with (cDAI, tDAI) being (3, 4); and for the fourth carrier, downlink assignment on a second slot with (cDAI, tDAI) being (4, 4).

The present disclosure describes various embodiments for applying dynamic codebooks for hybrid automatic repeat request acknowledgement (HARQ-ACK) feedback.

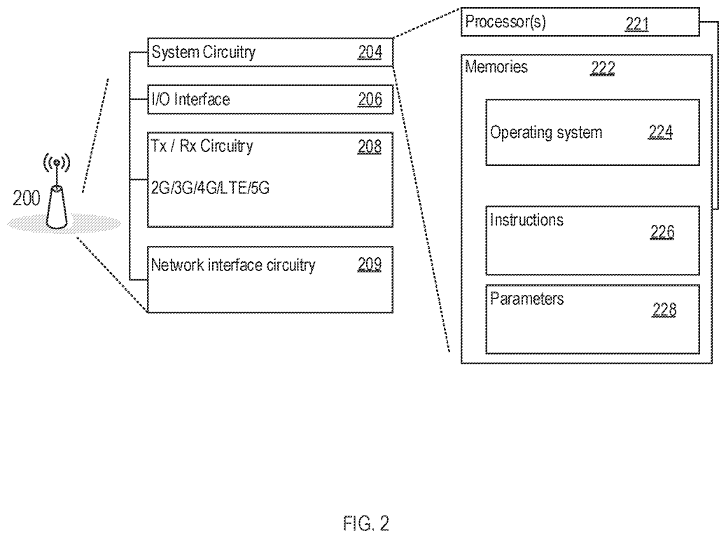

FIG. 2 shows an exemplary a radio access network or a wireless communication base station 200. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

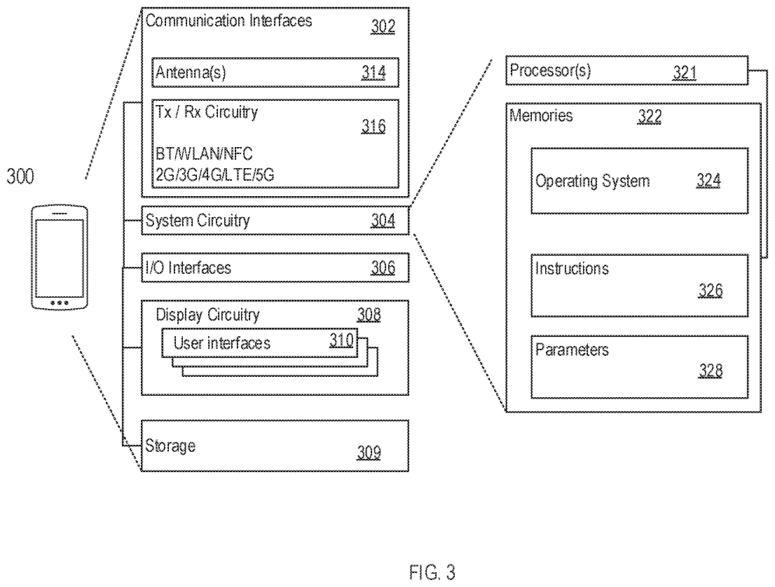

FIG. 3 shows an exemplary user equipment (UE) 300. The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several embodiments of methods and devices for applying dynamic codebooks for hybrid automatic repeat request acknowledgement (HARQ-ACK) feedback, which may be implemented, partly or totally, on the wireless network base station and/or the user equipment described above in FIGS. 2 and 3.

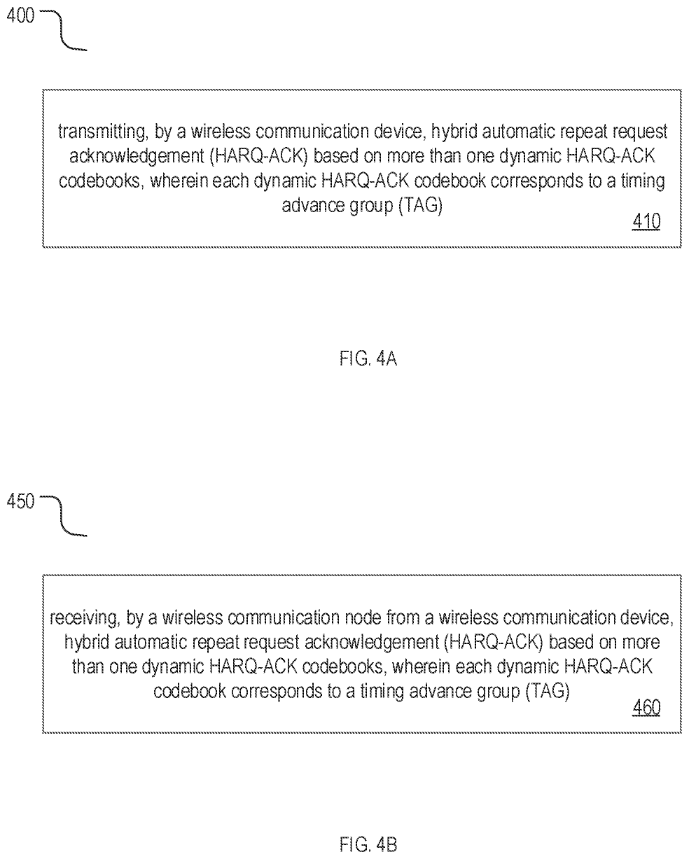

In various embodiments, FIG. 4A shows a flow diagram of a method 400 for wireless communication. The method 400 may include: step 410, transmitting, by a wireless communication device, hybrid automatic repeat request acknowledgement (HARQ-ACK) based on more than one dynamic HARQ-ACK codebooks, wherein each dynamic HARQ-ACK codebook corresponds to a timing advance group (TAG).

In some implementations, each dynamic HARQ-ACK codebook is used for a number of carriers only belonging to the TAG corresponded by the dynamic HARQ-ACK codebook.

In some implementations, for a dynamic HARQ-ACK codebook corresponding to a TAG: a counter downlink assignment index (cDAI) field comprised in a downlink control information (DCI) is counted based on a number of carriers only belonging to the TAG; and a total downlink assignment index (tDAI) field comprised in the DCI for the dynamic HARQ-ACK codebook is used for a number of carriers only belonging to the TAG.

In some implementations, a TAG index field comprised in a DCI indicates a TAG, wherein the TAG corresponds to a dynamic HARQ-ACK codebook for a scheduled physical downlink shared channel (PDSCH).

In some implementations, the method 400 may further include receiving, by the wireless communication device, configuration information, wherein: the configuration information comprises mapping between a dynamic HARQ-ACK codebook and a TAG, and the dynamic HARQ-ACK codebook is used for a number of carriers only belonging to the TAG.

In some implementations, dynamic HARQ-ACK codebook information comprised in a DCI indicates a dynamic HARQ-ACK codebook for a scheduled physical downlink shared channel (PDSCH).

In various embodiments, FIG. 4B shows a flow diagram of a method 450 for wireless communication. The method 450 may include: step 460, receiving, by a wireless communication node from a wireless communication device, hybrid automatic repeat request acknowledgement (HARQ-ACK) based on more than one dynamic HARQ-ACK codebooks, wherein each dynamic HARQ-ACK codebook corresponds to a timing advance group (TAG).

In some implementations, each dynamic HARQ-ACK codebook is used for a number of carriers only belonging to the TAG corresponded by the dynamic HARQ-ACK codebook.

In some implementations, for a dynamic HARQ-ACK codebook corresponding to a TAG: a counter downlink assignment index (cDAI) field comprised in a downlink control information (DCI) is counted based on a number of carriers only belonging to the TAG; and a total downlink assignment index (tDAI) field comprised in the DCI for the dynamic HARQ-ACK codebook is used for a number of carriers only belonging to the TAG.

In some implementations, a TAG index field comprised in a DCI indicates a TAG, wherein the TAG corresponds to a dynamic HARQ-ACK codebook for a scheduled physical downlink shared channel (PDSCH).

In some implementations, the method 450 may further include transmitting, by the wireless communication node, configuration information, wherein: the configuration information comprises mapping between a dynamic HARQ-ACK codebook and a TAG, and the dynamic HARQ-ACK codebook is used for a number of carriers only belonging to the TAG.

In some implementations, dynamic HARQ-ACK codebook information comprised in a DCI indicates a dynamic HARQ-ACK codebook for a scheduled physical downlink shared channel (PDSCH).

### Embodiment 1

The present disclosure describes one non-limiting embodiment, wherein when the codebook type for HARQ ACK/NACK feedback is configured by UE as dynamic codebook, UE determines the number of dynamic codebooks according to the number of configured TAGs, and each dynamic codebook corresponds to one TAG.

In some implementations, a size of the dynamic codebook may be related to the number of component carriers only belonging to the corresponding TAG, and may not be affected by the number of component carriers in other TAGs.

In some implementations, for an inter-TAG CA and a configured dynamic codebook, UE receives a DCI scheduling a PDSCH on one component carrier. The counter DAI and the total DAI in the DCI are determined only based on downlink assignment on the carrier and downlink assignment on other carriers belonging to the same TAG.

In some implementations, for an inter-TAG CA, UE may apply more than one dynamic HARQ-ACK codebooks for HARQ ACK/NACK feedback, wherein each dynamic HARQ-ACK codebook corresponds to one TAG.

For a non-limiting example, referring to the schematic diagram in FIG. 1C, for CA, the UE may receive downlink data on the four component carriers of a primary cell (pcell, 181), a secondary cell 1 (scell1, 182), a secondary cell 2 (scell2, 183), and a secondary cell 3 (scell3, 184). The pcell and scell1 may belong to the TAG1, and the scell2 and scell3 may belong to the TAG2. UE may apply two dynamic codebooks for HARQ ACK/NACK feedback. One dynamic codebook is used for HARQ ACK/NACK feedback for the pcell and scell1, and the other dynamic codebook is used for HARQ ACK/NACK feedback for the scell2 and scell3. The above non-limiting example shows that the UE performs HARQ ACK/NACK feedback based on the TAG-specific dynamic codebook.

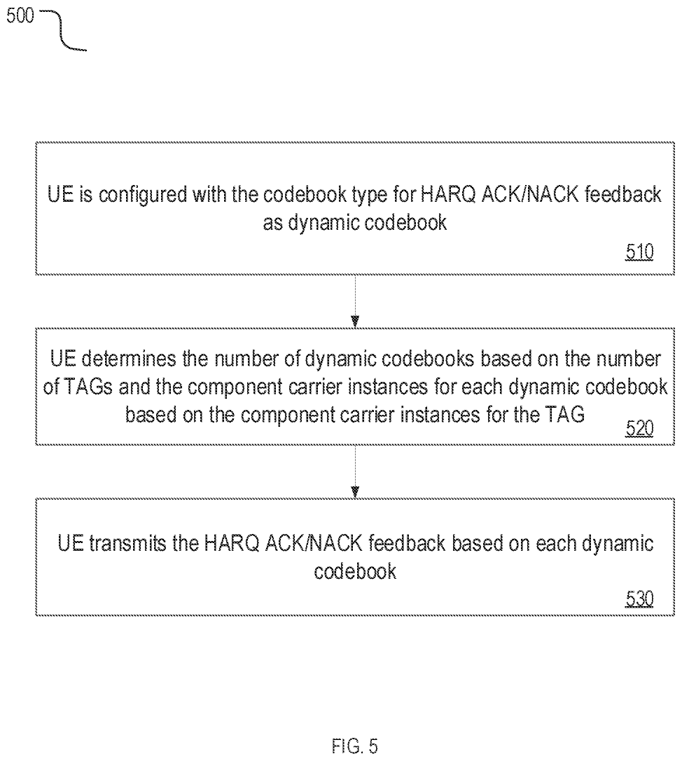

FIG. 5 shows a flow diagram of a method 500 for UE processing the TAG-specific dynamic codebook. The method 500 may include a portion or all of the following steps: step 510, UE is configured with the codebook type for HARQ ACK/NACK feedback as dynamic codebook; step 520, UE determines the number of dynamic codebooks based on the number of TAGs and the component carrier instances for each dynamic codebook based on the component carrier instances for the TAG; step 530, UE transmits the HARQ ACK/NACK feedback based on each dynamic codebook.

Referring to step 510, UE is configured with the codebook type of HARQ ACK/NACK feedback as dynamic codebook. When UE is configured with the HARQ-ACK codebook type as dynamic codebook through high layer signaling (NR RRC IE). UE may use that the dynamic HARQ-ACK codebooks for HARQ ACK/NACK feedback. In some implementations, UE may obtain cumulative downlink assignment and total downlink assignment based on the cDAI and tDAI in the DCI scheduling PDSCH.

Referring to step 520, UE determines the number of dynamic codebooks based on the number of TAGs and the component carrier instances for each dynamic codebook based on the component carrier instances for the TAG. In some implementations, UE may determine the number of dynamic codebooks for HARQ ACK/NACK feedback according to the number of configured TAGs. Since each dynamic codebook corresponds to a TAG, UE may determine the component carrier instances for each dynamic codebook according to the component carrier instances for each TAG.

Referring to step 530, UE feeds back HARQ ACK/NACK based on each dynamic codebook. In some implementations, UE feeds back the HARQ ACK/NACK for PDSCH on each component carrier by using the dynamic codebook to which the component carrier corresponds.

### Embodiment 2

The present disclosure describes another non-limiting embodiment, wherein the TAG-specific dynamic codebook mechanism is generated based on the DAI field (tDAI and/or cDAI) in the DCI. In some implementations, DCI may include counter DAI information and total DAI information. The value of counter DAI indicates the accumulated number of received downlink assignments so far for a TAG. In some implementations, the statistical sequence of the accumulated number is as follows: firstly according to the ascending order of the serving cell indexes belonging to the TAG, and then according to the ascending order of the scheduled PDSCH in the time domain for the TAG. The value of total DAI indicates the total number of received downlink assignments so far for the TAG.

In some implementations, when UE receives a downlink assignment on a component carrier, UE may determine which TAG the component carrier belongs to, and all the other component carriers under the TAG. UE obtains the counter DAI information and total DAI information in the DCI, and determines the total number of downlink assignments received under the TAG so far, and an accumulated number for the downlink assignments received so far under the TAG.

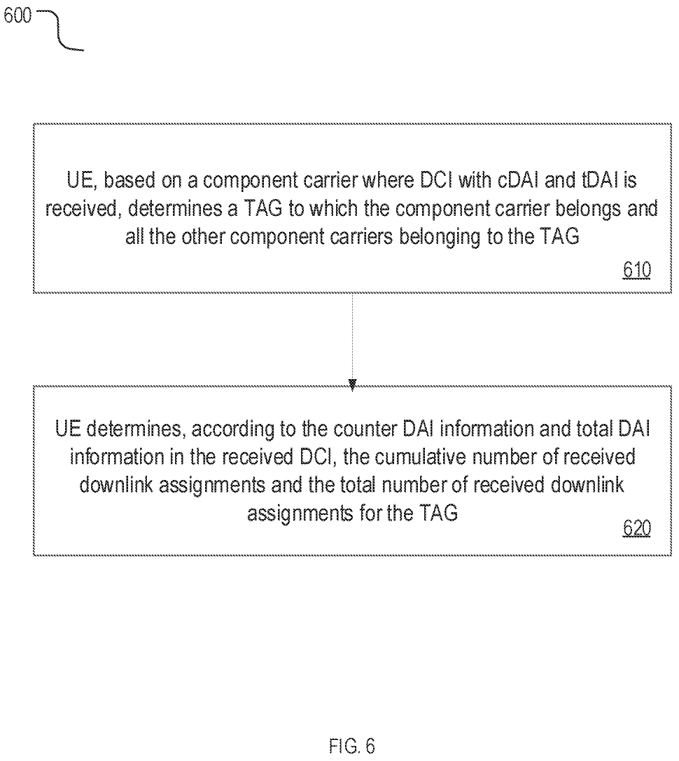

FIG. 6 shows a flow diagram of a method 600 for a UE processing the counter DAI information and total DAI information in the DCI for a TAG. The method 600 may include a portion or all of the following steps: step 610, UE, based on a component carrier where DCI with cDAI and tDAI is received, determines a TAG to which the component carrier belongs and all the other component carriers belonging to the TAG; step 620, UE determines, according to the counter DAI information and total DAI information in the received DCI, the cumulative number of received downlink assignments and the total number of received downlink assignments for the TAG, and UE determines the position for the downlink assignment in the dynamic HARQ-ACK codebook.

Referring to step 610, UE receives a DCI with cDAI and tDAI on a component carrier. In some implementations, according to the TAG configuration information for the component carrier, UE determines a TAG to which the component carrier belongs. In some implementations, according to the TAG configuration information, UE determines all the other component carriers belonging to the TAG.

Referring to step 620, UE determines, according to the counter DAI information and total DAI information in the received DCI, the cumulative number of received downlink assignments and the total number of received downlink assignments for the TAG. Counter DAI information in the DCI is used to indicate the cumulative number of received downlink assignment so far and total DAI information in the DCI is used to indicate the total number of received downlink assignment so far for the TAG. UE may judge whether miss a downlink assignment based on front and back multiple pairs of counter DAI information and total DAI information.

UE determines the position for the downlink assignment in the dynamic HARQ-ACK codebook to transmit HARQ ACK/NACK feedback information. In some implementations, dynamic HARQ-ACK codebook may be bit string, wherein each bit corresponds to HARQ information (such as ACK or NACK) for a downlink assignment. The size of dynamic HARQ-ACK codebook is determined based on the total number of downlink assignments corresponded by a TAG.

### Embodiment 3

The present disclosure describes another non-limiting embodiment, wherein UE may receive DCI including TAG information, so that UE may determine a dynamic codebook based on correspondence between TAG and dynamic codebook. In some implementations, UE may obtain the component carrier instances for the dynamic codebook based on the component carrier instances covered by the TAG.

In some implementations, a TAG index (TAG-ID) may be used to indicate TAG information, and DCI contains a field for TAG-ID. UE receives the TAG-ID field in the DCI to obtain TAG information.

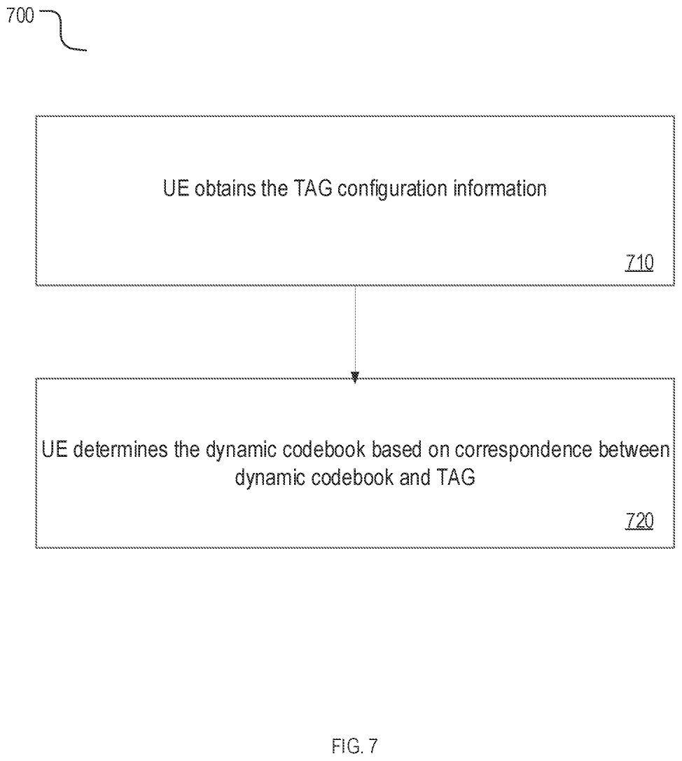

FIG. 7 shows a flow diagram of a method 700 for UE acquiring TAG information in the DCI. The method 700 may include a portion or all of the following steps: step 710, UE obtains the TAG configuration information; step 720, UE determines the dynamic codebook based on correspondence between dynamic codebook and TAG.

Referring to step 710, UE obtains the TAG configuration information. In some implementations, UE may receive a serving cell configuration information which includes the TAG-ID. The TAG-ID may indicate that the TAG to which the serving cell (carrier) belongs. In some implementations, UE may acquire all component carrier instances under the TAG indicated by the TAG-ID.

Referring to step 720, UE determines the dynamic codebook based on correspondence between dynamic codebook and TAG. In some implementations, since a dynamic codebook correspond to a TAG, UE determines the dynamic codebook from TAG information, such as TAG-ID indicated in the DCI.

### Embodiment 4

The present disclosure describes another non-limiting embodiment, wherein DCI may include dynamic codebook information. In some implementations, radio resource configuration information includes the correspondence between the dynamic codebook and the component carrier instances.

In some implementations, the configuration information such as the radio resource control (RRC) information element (IE) received by UE includes dynamic codebook information, which is used to indicate correspondence between the dynamic codebook and the component carrier instances. The methods for dynamic codebook configuration information include, but are not limited to: a RRC IE representing the dynamic codebook information, or a RRC IE representing the dynamic codebook index.

In some implementations, the correspondence between the dynamic codebook and the component carrier instances may be referred as a mapping. The ways of representing the correspondence between the dynamic codebook and the component carrier instances may include, but are not limited to: a dynamic codebook index in the serving cell configuration information, or one or more serving cell indexes in the dynamic codebook configuration information, or a separate configuration information including the dynamic codebook index and one or more serving cell indexes.

In some implementations, a dynamic codebook information is included in the Layer 1 signaling. For example, UE may receive a dynamic codebook information indicated in the DCI. In some implementations, the ways of indicating the dynamic codebook in the DCI may include, but be not limited to: a field in the DCI indicates a dynamic codebook index, or a field in the DCI corresponds to a dynamic codebook.

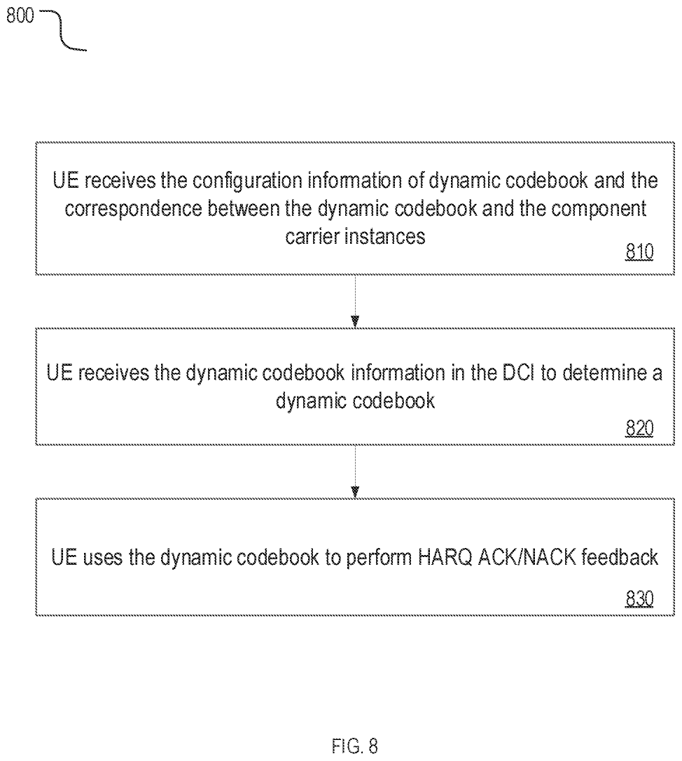

FIG. 8 shows a flow diagram of a method 800 for UE receiving dynamic codebook information in DCI. The method 800 may include a portion or all of the following steps: step 810, UE receives the configuration information of dynamic codebook and the correspondence between the dynamic codebook and the component carrier instances; step 820, UE receives the dynamic codebook information in the DCI to determine a dynamic codebook; step 830, UE uses the dynamic codebook to perform HARQ ACK/NACK feedback.

The present disclosure describes methods, apparatus, and computer-readable medium for wireless communication. The present disclosure addressed the issues with applying dynamic codebooks for hybrid automatic repeat request acknowledgement (HARQ-ACK) feedback. The methods, devices, and computer-readable medium described in the present disclosure may facilitate the performance of wireless communication by applying dynamic codebooks for HARQ-ACK feedback, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a wireless communication device, hybrid automatic repeat request acknowledgement (HARQ-ACK) based on more than one dynamic HARQ-ACK codebooks, wherein each dynamic HARQ-ACK codebook corresponds to a timing advance group (TAG).

2. The method according to claim 1, wherein:
each dynamic HARQ-ACK codebook is used for a number of carriers only belonging to the TAG corresponded by the dynamic HARQ-ACK codebook.

3. The method according to claim 1, wherein:
for a dynamic HARQ-ACK codebook corresponding to a TAG:
a counter downlink assignment index (cDAI) field comprised in a downlink control information (DCI) is counted based on a number of carriers only belonging to the TAG; and
a total downlink assignment index (tDAI) field comprised in the DCI for the dynamic HARQ-ACK codebook is used for a number of carriers only belonging to the TAG.

4. The method according to claim 1, wherein:
a TAG index field comprised in a DCI indicates a TAG, wherein the TAG corresponds to a dynamic HARQ-ACK codebook for a scheduled physical downlink shared channel (PDSCH).

5. The method according to claim 1, further comprising:
receiving, by the wireless communication device, configuration information, wherein:
the configuration information comprises mapping between a dynamic HARQ-ACK codebook and a TAG, and
the dynamic HARQ-ACK codebook is used for a number of carriers only belonging to the TAG.

6. The method according to claim 1, wherein:
dynamic HARQ-ACK codebook information comprised in a DCI indicates a dynamic HARQ-ACK codebook for a scheduled physical downlink shared channel (PDSCH).

7. A method for wireless communication, comprising:
receiving, by a wireless communication node from a wireless communication device, hybrid automatic repeat request acknowledgement (HARQ-ACK) based on more than one dynamic HARQ-ACK codebooks, wherein each dynamic HARQ-ACK codebook corresponds to a timing advance group (TAG).

8. The method according to claim 7, wherein:
each dynamic HARQ-ACK codebook is used for a number of carriers only belonging to the TAG corresponded by the dynamic HARQ-ACK codebook.

9. The method according to claim 7, wherein:
for a dynamic HARQ-ACK codebook corresponding to a TAG:
a counter downlink assignment index (cDAI) field comprised in a downlink control information (DCI) is counted based on a number of carriers only belonging to the TAG; and
a total downlink assignment index (tDAI) field comprised in the DCI for the dynamic HARQ-ACK codebook is used for a number of carriers only belonging to the TAG.

10. The method according to claim 7, wherein:
a TAG index field comprised in a DCI indicates a TAG, wherein the TAG corresponds to a dynamic HARQ-ACK codebook for a scheduled physical downlink shared channel (PDSCH).

11. The method according to claim 7, further comprising:
transmitting, by the wireless communication node, configuration information, wherein:
the configuration information comprises mapping between a dynamic HARQ-ACK codebook and a TAG, and
the dynamic HARQ-ACK codebook is used for a number of carriers only belonging to the TAG.

12. The method according to claim 7, wherein:
dynamic HARQ-ACK codebook information comprised in a DCI indicates a dynamic HARQ-ACK codebook for a scheduled physical downlink shared channel (PDSCH).

13. (canceled)

14. (canceled)

15. An apparatus comprising:
a memory storing instructions; and
at least one processor in communication with the memory, wherein, when the at least one processor executes the instructions, the at least one processor is configured to cause the apparatus to perform:
transmitting hybrid automatic repeat request acknowledgement (HARQ-ACK) based on more than one dynamic HARQ-ACK codebooks, wherein each dynamic HARQ-ACK codebook corresponds to a timing advance group (TAG).

16. The apparatus according to claim 15, wherein:
a TAG index field comprised in a DCI indicates a TAG, wherein the TAG corresponds to a dynamic HARQ-ACK codebook for a scheduled physical downlink shared channel (PDSCH).

17. The apparatus according to claim 15, wherein, when the at least one processor executes the instructions, the at least one processor is configured to further cause the apparatus to perform:
receiving configuration information, wherein:
the configuration information comprises mapping between a dynamic HARQ-ACK codebook and a TAG, and
the dynamic HARQ-ACK codebook is used for a number of carriers only belonging to the TAG.

18. The apparatus according to claim 15, wherein:
dynamic HARQ-ACK codebook information comprised in a DCI indicates a dynamic HARQ-ACK codebook for a scheduled physical downlink shared channel (PDSCH).

19. An apparatus comprising:
a memory storing instructions; and
at least one processor in communication with the memory, wherein, when the at least one processor executes the instructions, the at least one processor is configured to cause the apparatus to perform:
receiving, from a wireless communication device, hybrid automatic repeat request acknowledgement (HARQ-ACK) based on more than one dynamic HARQ-ACK codebooks, wherein each dynamic HARQ-ACK codebook corresponds to a timing advance group (TAG).

20. The apparatus according to claim 19, wherein:
a TAG index field comprised in a DCI indicates a TAG, wherein the TAG corresponds to a dynamic HARQ-ACK codebook for a scheduled physical downlink shared channel (PDSCH).

21. The apparatus according to claim 19, wherein, when the at least one processor executes the instructions, the at least one processor is configured to further cause the apparatus to perform:
transmitting configuration information, wherein:
the configuration information comprises mapping between a dynamic HARQ-ACK codebook and a TAG, and
the dynamic HARQ-ACK codebook is used for a number of carriers only belonging to the TAG.

22. The apparatus according to claim 19, wherein:
dynamic HARQ-ACK codebook information comprised in a DCI indicates a dynamic HARQ-ACK codebook for a scheduled physical downlink shared channel (PDSCH).
